(19) United States
(12) Patent Application Publication
(10) Pub. No.: US 2024/0193321 A1
(43) Pub. Date: Jun. 13, 2024

(54) DEVICE AND METHOD, IN PARTICULAR COMPUTER-IMPLEMENTED METHOD, FOR TESTING

(71) Applicant: Robert Bosch GmbH, Stuttgart (DE)

(72) Inventors: Kai Sandmann, Kornwestheim (DE); Thomas Leyendecker, Kornwestheim (DE); Felix Birkhold, Ditzingen (DE); Florian Kuhn, Stuttgart (DE); Martin Schiegg, Korntal-Muenchingen (DE); Sebastian Gerwinn, Leonberg (DE)

(21) Appl. No.: 18/556,319

(22) PCT Filed: Apr. 20, 2022
(86) PCT No.: PCT/EP2022/060328

§ 371 Date: Oct. 19, 2023

(30) Foreign Application Priority Data
Apr. 20, 2021 (DE) 10 2021 109 923.4
Apr. 20, 2022 (DE) 10 2022 203 849.5

(51) Int. Cl. G06F 30/17; G06F 30/23; G06F 119/02

(52) U.S. Cl. CPC G06F 30/17; G06F 30/23; G06F 2119/02

(57) ABSTRACT

A device and a computer-implemented method for testing a machine having a plurality of components or for testing a component of a machine. The method includes: providing a set of input variables for a model, the set of input variables characterizing load factors on the machine or characterizing load factors on at least one component of the machine; selecting a subset of the set; mapping, by the model, the subset to an output variable of the model which characterizes a stress caused by the load factors in the case of at least one component of the machine; and determining a degree of damage, in particular a degree of fatigue, of the at least one component according to a set of output variables which contains the output variable.

### BACKGROUND INFORMATION

Testing a machine, which includes running the machine, requires the creation of a prototype and performing tests under real conditions for which many resources are needed.

### SUMMARY

According to an example embodiment of the present invention, a method—in particular a computer-implemented method—for testing a machine having a plurality of components or for testing a component of a machine, comprises: providing a set of input variables for a model, wherein the set of input variables characterizes load factors on the machine or load factors on at least one component of the machine; selecting a subset of the set; mapping—by the model—of the subset to an output variable of the model which characterizes a stress caused by the load factors in the case of at least one component of the machine.

This enables, preferably at an early stage of development, a significantly more efficient determination of the component-specific stress, and an assessment on the basis of stress distributions derived from a plurality, for example, ten thousand, of different stress scenarios or repetitions of tests with the same stress scenario. A prototype of the machine is not needed.

The method advantageously allows a derivation of functional loads for the evaluation and optimization of the machine behavior or component behavior, in particular an evaluation and/or adaptation/optimization of an operating strategy, for example for optimizing functional system variables—wherein the component can be part of this system—for example with respect to a consumption behavior.

In one aspect of the present invention, the component of the machine is, for example, a fuel cell component, an inverter for an electrical machine, a battery or a transmission, in particular for an electric vehicle, a fuel injection system, in particular for a hybrid vehicle. Furthermore, the component can be another component, in particular of a vehicle, for example a component of a drive train, of a steering system, of a braking system or of a safety system, such as a camera system or radar system, for example.

In one aspect of the present invention, the machine is a vehicle, a motorcycle or an electric bicycle, a train or an aircraft, or a ship.

According to an example embodiment of the present invention, preferably, a degree of damage, in particular a degree of fatigue, of the at least one component, is determined as a function of a set of output variables which contains the output variable. Such a stress or more generally a damage mechanism can in particular include wear, corrosion or generally fatigue and statistical failure. A degree of damage is to be understood in particular as an extent of damage caused by a stress or by a damage mechanism, in particular having a disadvantageous effect on the functionality, on the component or the machine.

According to an example embodiment of the present invention, the selection of the subset advantageously includes selecting an input variable that defines a route and selecting an input variable that defines a driver profile, and wherein the input variable that defines the route is selected from a plurality of input variables that define different routes, wherein the input variable that defines the driver profile is selected from a plurality of input variables that define different driver profiles. This makes it possible to simulate a large number of different driving cycles in order to determine stress and loading instead of a plurality of real test drives.

According to an example embodiment of the present invention, preferably, a plurality of different subsets is selected and mapped, wherein a distribution of the stress or fatigue is determined from the output variables resulting from the mapping of the different subsets. As a result, variations are provided which improve the ability to identify combinations of input variables which cause greater fatigue than others or a specific class of fatigue.

According to an example embodiment of the present invention, the method, in particular determining the degree of damage, preferably includes adding or multiplying output variables selected from the set of output variables. A consolidated damage of the output variables is thus provided for the selected output variables.

According to an example embodiment of the present invention, the method, in particular determining the degree of damage, preferably includes determining a frequency of occurrence of a property of the route, in particular a time of day, a starting time, a region, a duration, a distance or a type, either in a machine-specific statistic or in a machine-specific journal, and determining a weighting for the output variable as a function of the frequency, and adding or multiplying the output variable weighted with the weighting. The consolidated damage is thus provided for a specific property of the route.

According to an example embodiment of the present invention, the method, in particular determining the degree of stress, preferably includes selecting an operator, in particular a driver or user of the machine in the machine-specific statistic or in the machine-specific journal, determining a plurality of output variables in the set of output variables for the operator, and preferably determining the degree of damage with the plurality of output variables. The consolidated damage is thus provided for a specific operator.

According to an example embodiment of the present invention, the method, in particular determining the degree of damage, preferably includes selecting the machine-specific statistic from a set of machine-specific statistics. Machine-specific weightings are thus provided.

According to an example embodiment of the present invention, a device for testing a machine having a plurality of components or for testing a component of a machine is configured to carry out the steps of the method accordingly.

According to an example embodiment of the present invention, a computer program contains instructions which, when executed by a computer, cause the computer to carry out steps of the method accordingly.

Further advantageous aspects of the present invention will be apparent from the following description and the figures.

### BRIEF DESCRIPTION OF THE DRAWINGS

FIG. 1 schematically shows a part of a device 100 for testing, according to an example embodiment of the present invention.

FIG. 2 schematically shows steps in a method for testing, according to an example embodiment of the present invention.

FIG. 3 schematically shows a first example, according to the present invention.

FIG. 4 schematically shows a second example, according to the present invention.

### DETAILED DESCRIPTION OF EXAMPLE EMBODIMENTS

FIG. 1 schematically shows a part of a device 100 for testing. The device 100 is configured or can be configured for testing a machine having a plurality of components or for testing a component of a machine.

The device 100 comprises a database 102, a model 104, and an analyzer 106.

The database 102 contains a set of input variables for the model 104. Input variables characterize load factors on the machine or load factors on at least one component of the machine. The database 102 contains a plurality of input variables that define different routes and different driver profiles. The database 102 can include input variables that define different environmental conditions.

The input variables of the model 104 that define a route define, for example, a start of the route and an end of the route and/or a course of the route.

The route can be defined by geographic coordinates for real routes or by telemetry data from real trips. The route can be selected from a logbook. The route can be defined by synthetically generated data representing geographic coordinates or by telemetry data that do not come from real routes.

The input variables of the model that define a driver profile define, for example, a frequency and/or a mode of operating the throttle control system and/or brake control system. Further information about a general driving style, in particular tolerated speeds and a degree of smoothness of a driving style, is also preferably mapped in the model.

The input variables of the model that define an environmental condition preferably define climatic, geographic, traffic-related and/or legal environmental conditions, for example at least one of a temperature, a wind speed, a wind direction, a speed limit, a position of a speed limit, a position of a vehicle, and a position of a traffic jam.

Characteristic variables of the machine to be tested or a component thereof can also be selected as input variables of the model 104. A characteristic variable of the machine or of the component thereof can be selected from a range defined for this characteristic variable. These characteristic variables can define how the model 104 maps an input variable or input variables to an output variable or to output variables. The model 104 can contain parts which map an input variable or input variables to an output variable or to output variables. The model 104 can contain at least one part in order to map an input variable or input variables to an intermediate variable or intermediate variables. The model 104 can contain at least one part in order to map an intermediate variable to an output variable or to output variables. The model 104 can contain at least one part in order to map intermediate variables to an output variable or to output variables. The at least one part can be configured to map by means of at least one of the following operations: a function, an estimate, a finite element simulation, a characteristic curve or a table. This list is by way of example for operations and not exhaustive.

The model 104 is configured to map a subset of the set of input variables to a set of output variables of the model 104 which characterizes a stress caused by the load factors in the case of at least one component of the machine. In the example, the model 104 comprises a first part 108 and a second part 110. The first part 108 is configured to simulate global load variables. The subset of the set of input variables is mapped by the first part 108 to global load variables which are transferred as input to the second part 110. The second part 110 is configured for system simulation. The second part 110 is configured to map the input from the first part 108 to the set of output variables. An additional input into the second part 110 can be local load variables. In this aspect, the local load variables and the input from the first part 108 are mapped to the output variables.

The first part 108 can, for example, be configured to simulate the machine or the component thereof. In this example, the second part 110 can be configured to simulate a stress on the machine or the component thereof.

A non-exhaustive list of examples for global load variables is: speed, acceleration, gear. A non-exhaustive list of examples of components is a drive train of a vehicle. A non-exhaustive list of examples of local load variables is engine power or the pressure in an injection system.

The global load variable for the speed of a vehicle on a route is simulated, for example, by the first part 108, by reading an input variable from the database which defines the route data, e.g., telemetry data for the route, by determining a driver behavior on the route with a driver model that is parametrized according to the input variables read from the database, by determining a driving resistance on the route using a physical model that is parametrized according to the route data and preferably vehicle-specific data, by determining a tolerance with a stochastic model of tolerances that is parametrized according to the driver behavior, and with input variables read from the database, which represent the traffic, and by determining the speed with a data-driven model for generating a speed curve on the route as a function of the output of the other models.

The set of output variables for the speed curve is simulated by the second part 110, for example, using a simulation model which, when the speed curve is applied, determines the loading of components of a drive train of the vehicle. In the example, the route data, in particular telemetry data describing a gradient curve of the route, are an additional input for the second part 110. The speed curve and the gradient curve are aligned in this example. In the example, the simulation model determines the acceleration from the speed curve and a stress on the drive train as a function of the speed, the acceleration, and the gradient of the route. In one example, a motor torque, a motor revolution per minute, and/or a motor power are determined as a function of the speed, the acceleration, and the gradient from a reverse model of the drive train.

The analyzer 106 is configured to determine a degree of fatigue of the at least one component as a function of the set of output variables.

The analyzer 106 can be configured to determine a time profile of the stress.

The analyzer 106 can be configured to determine a distribution of the stress via a variation of inputs into the model 104. The analyzer 106 can be configured to determine a distribution of the stress curves via the variation of inputs.

The analyzer 106 is configured to determine the damage, in particular fatigue, of the machine or of the component thereof from the distribution or the time profile of the stress. The analyzer 106 is configured to determine the damage, in particular fatigue, on the basis of a count, for example a rainflow count, of a linear damage accumulation, of an analysis of the high-cycle damage, in particular high-cycle fatigue, or of the low-cycle damage, in particular low-cycle fatigue. As stated above, such a stress can in particular include wear, corrosion or generally fatigue, and statistical failure.

In one example, the distribution results from a variation in the driver behavior and the routes. In addition, the distribution can be determined for a variation in application cases of the machine. A non-exhaustive list of examples of damage, in particular of fatigue, is the damage, in particular fatigue, of the component caused by pressure changes in the fuel injection system of the engine.

The analyzer 106 can be configured to determine combinations of input variables which cause greater damage, in particular fatigue, than other combinations. Critical combinations are determined, for example, by detecting a distribution which falls within a prespecified percentile compared to other distributions resulting from variations.

The analyzer 106 can be configured to determine a combination of input variables that are characteristic of a fatigue class.

The result of the analysis can be used to define further real measurements.

The device 100 is configured to select the subset. The device 100 is configured to select an input variable that defines a route, an input variable that defines a driver profile and an input variable that defines at least one environmental condition for the subset. The device 100 is configured to provide the model 104 with the subset and to provide the analyzer 106 with the output resulting from the input. The device 100 can be configured to output the damage, in particular fatigue. The device 100 is configured, for example, to select a plurality of different subsets to be mapped and to determine a distribution of the stress or damage, in particular fatigue, which is determined from the output variables resulting from the mapping of the different subsets.

The device 100 can comprise at least one processor in order to operate accordingly the database 102, the model 104, the analyzer 106, and an output for the distribution.

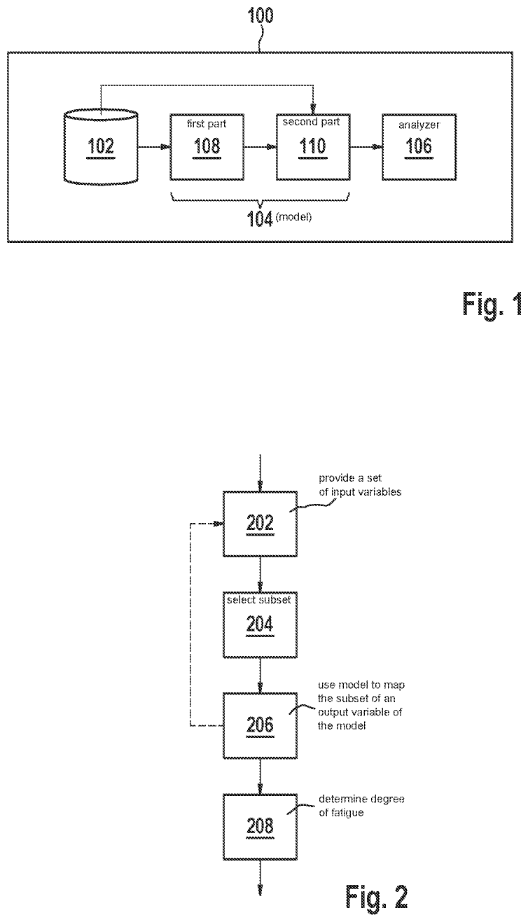

The device 100 is configured to carry out the steps of the method, which is described below with reference to FIG. 2.

The model 104 can be at least partially an artificial neural network. The analyzer 106 can be at least partially a classifier. The classifier can be an artificial neural network or contain one.

The artificial neural networks can be pre-trained for modeling the machine or a component thereof.

The method in the example is computer-implemented. The method can be carried out at least in part by dedicated hardware, at least for determining the output of the model 104 or of the analyzer 106.

The method is carried out for testing a machine having a plurality of components or for testing a component of a machine.

The model 104 and the analyzer 106 are configured to model and analyze the machine or a component thereof. The model 104 characterizes load factors on the machine or load factors on at least one component of the machine.

In a step 202, a set of input variables is provided for the model 104.

In a step 204, a subset of the set is selected. Selecting the subset includes selecting an input variable that defines a route, an input variable that defines a driver profile and selecting an input variable that defines at least one environmental condition.

The input variable that defines the route is selected from a plurality of input variables that define different routes.

The input variable that defines the driver profile is selected from a plurality of input variables that define different driver profiles.

The input variable that defines the at least one environmental condition is selected from a plurality of input variables that define different environmental conditions.

The at least one environmental condition can be selected as a function of a time specification, in particular a season, a time of day, a day of the year or a day of the week.

In a step 206, the model is used to map the subset to an output variable of the model, which characterizes a stress caused by the load factors in the case of at least one component of the machine. Different subsets are mapped from the model to different output variables. A set of output variables of the model includes a plurality of output variables which characterize a stress caused by the load factors in different scenarios in the case of at least one component of the machine.

In one example, the set of output variables for different operators of the machine contains different output variables which are associated with different properties of an operation of the machine.

The operator can be a driver or user of the machine.

In one example, the set of output variables for n different operators and o different properties contains a mapping to different degrees of fatigue D:

| | | | |
|---|---|---|---|
| | Property 1, | . . . , | Property o |
| Operator 1: | D11, | . . . , | D1o |
| . . . | | | |
| Operator n: | Dn1, | . . . , | Dno |

Exemplary properties of a vehicle are road types: “city”, “rural”, “freeway”.

Examples of properties of a vehicle driving characteristic are: “duration”, “distance of a trip”.

The database 102 can contain a mapping of the properties to the plurality of input variables that define different routes or different driver profiles. The properties can be available from metadata which are associated with the input variables.

Telemetry data can define a time profile of the input variable.

In one example, the set of output variables for n different operators contains a mapping to a total degree of fatigue D:

| | |
|---|---|
| Operator 1: | D1 |
| . . . | |
| Operator n: | Dn |

In a step 208, a degree of fatigue of the at least one component is determined as a function of the set of the output variables.

In one example, selected output variables in the set of output variables are added. Instead of the output variables being added, the output variables can also be multiplied.

In one example, a weighted sum or a weighted product of selected output variables in the set of output variables is determined.

The weighting can be determined from a machine-specific statistic or a machine-specific journal.

The machine-specific statistic can include a mapping of a machine to an apportionment of different properties of the operation. A set of machine-specific statistics can include individual apportionments for different machines. The set of machine statistics for m machines and o properties can include an apportionment S per machine, which adds up to up to 100% per machine:

| | | | |
|---|---|---|---|
| | Property 1, | . . . , | Property o |
| Machine 1: | S11, | . . . , | S1o |
| . . . | | | |
| Machine m: | Sn1, | . . . , | Sno |

The machine-specific journal can include a plurality of mappings of an operator to the property of the operation. The machine-specific journal can be a trip diary in which different operators are mapped to the property of respective operations. The trip diary for n operators, m trips and o types of properties can contain the following properties P:

| | | | |
|---|---|---|---|
| | Property 1, | . . . , | Property o |
| Operator 1 - Trip 1: | P11, | . . . , | P1o |
| . . . | | | |
| Operator n - Trip m: | Pn1, | . . . , | Pno |

In one example, a frequency of occurrence of a property of the route, in particular a duration, a distance, or a type—either in the machine-specific statistic or in the machine-specific journal—is determined. The frequency of occurrence can be the percentage in the apportionment. The weighting for the output variable can be determined as a function of the frequency.

In one example, the degree of fatigue is determined on the basis of a machine-specific statistic selected from the set of machine-specific statistics. More precisely, selected output variables from the set of output variables are mapped to a total degree of fatigue D per operator and machine:
Operator 1—Machine 1: D11
. . .
Operator n—Machine 1: Dn1
. . .
Operator 1—Machine m: D1m
. . .
Operator n—Machine m: Dnm

In one aspect of the example, steps 204 and 206 are repeated in order to select a plurality of different subsets and to map them individually to the plurality of sets of output variables. In one example, a distribution of the stress or fatigue is determined from the output variables which result from the mapping of the different subsets.

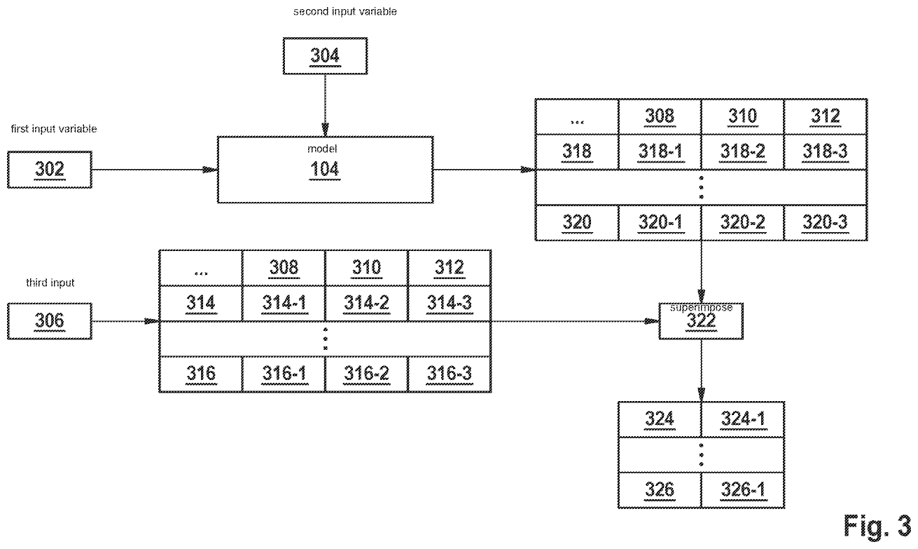

In an example shown in FIG. 3, the database 102 contains:
geo-referenced routes of trips in the real world from location A to location B
mobility studies including logbooks
systematically recorded field data, for example in a vehicle fleet, in particular recorded by load counters,
high-resolution telemetry data.

A first input variable 302, which provides the driver profile, is selected from the database 102.

A second input variable 304, which provides the road type, is selected from the database 102.

A third input 306 is a route division. In the example, a road-type-specific division is provided.

The example uses road-type-specific properties: “city” 308, “rural” 310 and “freeway” 312.

The road-type-specific splitting-up is provided for a plurality of different vehicles. FIG. 3 represents the splitting-up for a first vehicle 314 of the plurality of vehicles and a last vehicle 316 of the plurality of vehicles. Individual division values for the properties “city” 308, “rural” 310 and “freeway” 312 are determined for the different vehicles. FIG. 3 shows by way of example the division values 314-1, 314-2, 314-3 for the first vehicle 314 and the division values 316-1, 316-2, 316-3 for the last vehicle 316.

The first input 302 and the second input 304 are mapped with the model 104 to road-type-specific results for a plurality of driver profiles. FIG. 3 shows the road-type-specific results 318-1, 318-2, 318-3 for a first driver profile 318 and the road-type-specific results 320-1, 320-2, 320-3 for the last driver profile 320 of the plurality of driver profiles.

The road-type-specific division and the road-type-specific results are superimposed by a function 322. According to one example, the function 322 calculates relative damage values for each driver profile on the basis of the distance traveled. According to one example, after selection of a driver profile/vehicle combination from a pool of available profile/vehicle combinations, a weighted sum is calculated by the relative, road-type-specific values being multiplied by the corresponding road component, added up and extrapolated to a design target represented by a target distance or target operating time. In the example, the function 322 thus determines a total damage, in particular the degree of fatigue, by means of a weighted sum per driver profile/vehicle combination for a plurality of different driver profile/vehicle combinations. FIG. 3 shows a first total damage 324-1 for a first combination 324 and a second total damage 326-1 for a last combination 326.

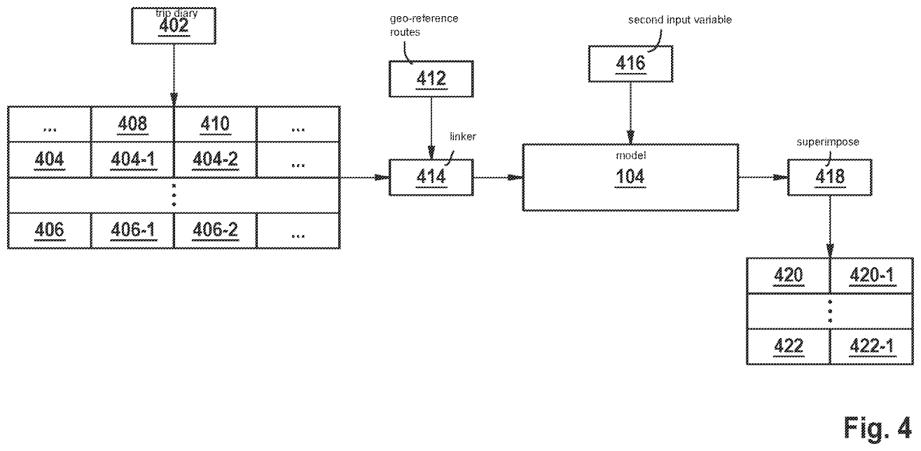

In an example shown in FIG. 4, the database 102 contains a plurality of trip diaries 402, for example driver logs.

The trip diaries 402 contain a plurality of user/trip combinations. A first user/trip combination 404 and a last user/trip combination 406 of the plurality of user/trip combinations are shown in FIG. 4. In the example, the trips are identified by the following properties: the day of the week of the trip, starting time of the trip, region in which the trip is geographically located, duration of the trip, distance of the trip. FIG. 4 schematically shows a first of these properties 408 and a second of these properties 410. Other properties can also be defined. FIG. 4 shows a first duration 404-1 and a first distance 404-2 for the first user/trip combination 404 and a second duration 406-1 and a second distance 406-2 for the last user/trip combination 406.

The user/trip combinations and geo-reference routes 412 from the database 102 are linked by a linker 414 to a first input variable for the model 104.

The linker 414 can compare metadata of the geo-reference routes 412 with the properties of the trips from the user/trip combinations in order to find potential routes as the first input variable into the database 102 that have properties in their metadata similar to a trip from the trip diary 402.

A large number of potential routes can be identified in a large quantity of telemetry data. In order to reduce the amount of data and maintain a representative selection, potential routes can be processed, for example, with a k-means clustering algorithm in order to group the routes into groups having similar properties. In this example, the first input variable is a center of the group that has similar properties to the trip.

A second input variable 416 which provides the driver profile is selected from the database 102. In the example, a driver profile is selected for each trip diary.

The output variables of the model 104 for different trips of the same user are superimposed with a function 418. According to one example, the sum of damage values and total distance and duration is calculated for each individual user. The damage values are then extrapolated to a design target which is represented, for example, by a target distance or a target operating time. In the example, the function 418 determines a total damage, in particular the degree of fatigue, by means of a sum of the output variables. FIG. 4 shows a first total damage 420-1 for a first user 420 and a second total damage 422-1 for a last user 422.

The examples shown describe the use for calculating a damage total, wherein the use is not limited to damage totals, since statistical values, such as mean values of component loads, or histograms or load spectra can also be used instead.

In the following, on the basis of further examples it is described how the output variable is determined in particular by the model 104 and the analyzer 106 with damage accumulation.

### 1) Fuel Cell Component:

An exemplary design element of the fuel cell component is a turbine wheel of an electrical air compressor for an in particular mobile fuel cell system. In this context, mobile means that the dimensions of the fuel cell are suitable for driving a passenger vehicle.

An exemplary damage mechanism for the fuel cell component is fatigue, which is based on centrifugal forces.

In this aspect, the model 104 includes the following parts:
i. a part configured to calculate a vehicle wheel power based on a driving resistance equation as a function of the vehicle speed, the gradient, the vehicle mass and the drag coefficient. The input variables of this equation are, for example, the acceleration resistance, the air resistance, the rolling resistance and the gradient resistance.
ii. a part configured to calculate a direct current power (DC power) required to generate an alternating current power (AC supply) for an electrical machine in order to drive the vehicle. The alternating current is calculated, for example, from the vehicle wheel power while taking into account detailed power losses in the drive train, for example transmission loss and differential loss. The direct current is calculated, for example, from the alternating current, taking into account detailed power losses in an AC/DC inverter.
iii. a part which is configured to calculate a power split of fuel cell stack and high-voltage battery from the DC power on the basis of an operating strategy for the power split of the vehicle which takes into account other requirements, such as maximum dynamics of the fuel cell stack and charge state of the battery.
iv. a part configured to calculate a stack current required by the stack to supply the DC power. The stack current is calculated, for example, on the basis of a detailed stack model or a characteristic curve model.
v. a part configured to determine a turbine rotational speed, rpm, from the stack current. Here the stack current is a reference variable of the fuel cell subsystems. Optionally, a height above sea level, an outside temperature, and an air humidity are also determined by this part.

In the example, a time-resolved turbine rotational speed, rpm, is determined. This turbine rotational speed is input into a damage model.

The analyzer 106 contains the damage model.

The damage model is configured to derive a centrifugal force from the turbine rotational speed.

In the example, the damage model is configured to carry out a rainflow count of the time-resolved turbine rotational speed with a prespecified resolution and to calculate the damage accumulation on the basis of a Wöhler curve.

The output of the damage model is the output variable which represents the damage accumulation.

### 2) Inverter for an Electrical Machine

An exemplary design element of the inverter is B6 bridges of a power module. In this example, the inverter is an electrical air compressor for mobile fuel cell systems. In this context, mobile means that the dimensions of the fuel cell are suitable for driving a passenger vehicle. Any other inverter can be tested in the same way.

An exemplary damage mechanism for the inverter is based on thermal stress due to a high rate of temperature change.

In this aspect, the model 104 contains the parts i), ii), iii), iv), and the input variables, as described above. The model 104 additionally contains
v. a part configured to calculate the temperature of the B6 bridges on the basis of the stack current and a voltage at the inverter.

In the example, a time-resolved temperature is determined. This temperature is input into a damage model.

The analyzer 106 contains the damage model.

The damage model is configured to carry out a rainflow count of the time-resolved temperature with a prespecified resolution and to calculate the damage accumulation on the basis of a Wöhler curve.

The output of the damage model is the output variable which represents the damage accumulation.

### 3) High-Voltage Battery

In the example, the high-voltage battery contains a lithium-ion battery cell. An exemplary design element of the high-voltage battery is a housing of the cell.

An exemplary damage mechanism of the high-voltage battery is a fracture of the housing due to swelling of the battery cell. When a battery cell is being charged, it expands, i.e., it swells. This results in a load in the housing. The cell is compressed by the load in the housing. The damage mechanism for a battery having a plurality of cells therein can be tested in the same way.

In this aspect, the model 104 contains the parts i), ii) and the input variables, as described above. The model 104 additionally contains
iii. a part which is configured to calculate a series of states of charge (SOC) on the basis of a battery control system and limits in a circuit at the battery.
iv. a part which is configured to calculate a stress series from the SOC series. In the example, a stress in the battery housing is determined as a function of a value of the SOC series in a finite element simulation. In the example, the values from the SOC series are transformed into a stress series.

The analyzer 106 contains the damage model.

The damage model is configured to carry out a rainflow count of the load cycles of the battery and to calculate the damage accumulation on the basis of a Wohler curve. The load cycles can be counted on the basis of the SOC series, wherein a start of an increasing SOC indicates a start of a load cycle.

The output of the damage model is the output variable which represents the damage accumulation.

### 4) Transmission for an Electric Vehicle

In the example, the transmission for an electric vehicle has gearwheels with teeth. An exemplary design element of the transmission is a tooth of a gearwheel of the transmission.

An exemplary damage mechanism of the transmission is a fracture of the tooth, for example due to high torques. A further exemplary damage mechanism of the transmission is a pitting formation on a flank of the tooth, for example due to a high torque and to a high number of revolutions per minute, rpm.

In this aspect, the model 104 includes
i. a part which is configured to calculate a series of driving forces on the basis of vehicle properties, for example, mass, air resistance, rolling resistance, on the basis of the speed and on the basis of a gradient profile. The mass, the air resistance, the rolling resistance, the speed and the gradient profile are input variables according to this example.
ii. a part configured to calculate the torque at the tooth and/or the revolutions per minute based on a transmission ratio and an efficiency of the transmission. The transmission ratio and the efficiency are input variables according to this example.

Additional effects which limit a possible power of an electric motor of the electric vehicle can also be taken into account. This could be a power loss of the motor at high speeds or protection against overheating.
iii. a part configured to derive a retention-time characteristic map of the electric motor, for example, a duration at certain rpm and torque values.

The analyzer 106 contains the damage model.

The damage model is configured to calculate a number of revolutions at certain torque levels from the retention-time characteristic map. The damage model is configured to calculate the damage accumulation for each torque on the basis of a Wöhler curve.

In the example, individual Wöhler curves are defined for a tooth root and the tooth flank.

The output of the damage model is the output variable which represents the damage accumulation.

### 5) Fuel Injection System in a Hybrid Vehicle

An exemplary design element of the fuel injection system is a high-pressure pump, a fuel rail or a fuel injector.

An exemplary damage mechanism of the fuel injection system is damage, in particular fatigue, due to changes in the fuel pressure. Changes in fuel pressure can be induced by hybrid-vehicle-specific limits or operating conditions.

In this aspect, the model 104 includes
i. a part configured to calculate a vehicle wheel power as a function of the vehicle speed, the gradient, the vehicle mass and/or the drag coefficient. The vehicle speed, the gradient, the vehicle mass, and the drag coefficient are input variables according to this example. The vehicle wheel power is determined, for example, on the basis of a driving resistance equation composed of an acceleration resistance, an air resistance, a rolling resistance, and/or a gradient resistance as input variables according to this example.
ii. a part which is configured to determine, on the basis of the calculated wheel power and its time sequence, whether the internal combustion engine or the electric motor is being used for the drive.
iii. a part which is configured to calculate pressure changes in the injection system on the basis of the vehicle wheel power and the time sequence.

In the example, desired pressure changes generated by the pressure control system and undesired pressure changes are determined.

Undesired pressure changes are generated, for example, by thermal effects during electric driving periods, i.e., with the internal combustion engine switched off. Thermally induced pressure changes are a consequence of the thermal expansion of fuel in the self-contained injection system due to thermal equalization effects between cold fuel and hot motor parts in periods when the internal combustion engine is switched off.

Undesired pressure changes arise, for example, due to hydraulic leakage, for example in containers, in periods when the internal combustion engine is switched off.

In the example, the above-mentioned pressure changes, which can occur simultaneously, are combined.

The analyzer 106 contains the damage model.

The damage model is configured to carry out a rainflow count of the pressure at a prespecified resolution and to calculate the damage accumulation on the basis of a Wöhler curve.

The output of the damage model is the output variable which represents the damage accumulation.

1-12. (canceled)

13. A computer-implemented method for testing a machine having a plurality of components or for testing a component of a machine, the method comprising the following steps:
providing a set of input variables for a model, wherein the set of input variables characterizes load factors on the machine or on at least one component of the machine;
selecting a subset of the set;
mapping, by the model, the subset to an output variable of the model which characterizes a stress caused by the load factors on at least one component of the machine.

14. The method according to claim 13, further comprising:
determining a degree of damage including a degree of fatigue of the at least one component as a function of a set of output variables which contains the output variable.

15. The method according to claim 14, wherein the selection of the subset includes selecting an input variable that defines a route, and selecting an input variable that defines a driver profile, and wherein the input variable that defines the route is selected from a plurality of input variables that define different routes, wherein the input variable that defines the driver profile is selected from a plurality of input variables that define different driver profiles.

16. The method according to claim 14, wherein a plurality of different subsets is selected and mapped, wherein a distribution of the stress or the fatigue is determined from the output variables resulting from the mapping of the different subsets.

17. The method according to claim 14, wherein the determination of the degree of damage includes adding or multiplying selected output variables in the set of output variables.

18. The method according to claim 15, wherein the determination of the degree of damage includes:
determining a frequency of occurrence of a property of the route including a time of day or a starting time or a region or a duration or a distance or a type, either in a machine-specific statistic or in a machine-specific journal, and
determining a weighting for the output variable as a function of the frequency and adding or multiplying the output variable weighted with the weighting.

19. The method according to claim 18, wherein the determination of the degree of damage includes selecting an operator including a driver or user of the machine in a machine-specific statistic or a machine-specific journal, determining a plurality of output variables in the set of output variables for the operator, and determining the degree of damage with the plurality of output variables.

20. The method according to claim 19, wherein the determination of the degree of damage includes selecting the machine-specific statistic from a set of machine-specific statistics.

21. The method according to claim 13, wherein the component of the machine is a fuel cell component or an inverter for an electrical machine or a battery or a transmission, for an electric vehicle or for a fuel injection system or for a hybrid vehicle.

22. The method according to claim 13, wherein the machine is a vehicle or a motorcycle or an electric bicycle or a train or an aircraft or a ship.

23. A device for testing a machine having a plurality of components or for testing a component of a machine, the device configured to:
provide a set of input variables for a model, wherein the set of input variables characterizes load factors on the machine or on at least one component of the machine;
select a subset of the set;
map, by the model, the subset to an output variable of the model which characterizes a stress caused by the load factors on at least one component of the machine.

24. A non-transitory computer-readable medium on which is stored a computer program for testing a machine having a plurality of components or for testing a component of a machine, the computer program, when executed by a computer, causing the computer to perform the following steps:
providing a set of input variables for a model, wherein the set of input variables characterizes load factors on the machine or on at least one component of the machine;
selecting a subset of the set;
mapping, by the model, the subset to an output variable of the model which characterizes a stress caused by the load factors on at least one component of the machine.
